(19) United States
(12) Patent Application Publication
(10) Pub. No.: US 2026/0067659 A1
(43) Pub. Date: Mar. 5, 2026

(54) ALERT MANAGEMENT FOR DATA PROCESSING SYSTEMS USING OUT-OF-BAND METHODS

(71) Applicant: Dell Products L.P., Round Rock, TX (US)

(72) Inventors: MOHIT ARORA, Frisco, TX (US); LUIS ANTONIO VALENCIA REYES, Waxahachie, TX (US); VINODKUMAR VASUDEV OTTAR, McKinney, TX (US); ABEYE TESHOME, Austin, TX (US); RICHARD M. TONRY, Georgetown, TX (US); BASSEM EL-AZZAMI, Austin, TX (US); ADOLFO SANDOR MONTERO, Pflugerville, TX (US); RAJARAVI CHANDRA KOLLARAPU, Allen, TX (US)

(21) Appl. No.: 18/820,683

(22) Filed: Aug. 30, 2024

(51) Int. Cl. H04W 4/90; G06Q 50/26

(52) U.S. Cl. CPC H04W 4/90; G06Q 50/265

(57) ABSTRACT

Methods and systems for managing operation of a data processing system are disclosed. A management controller of the data processing system may obtain an alert via an out-of-band communication channel. The alert may be broadcasted by a service system using a wireless wide area network. A determination may be made regarding whether the alert is valid, and, if the alert is valid, then the management controller may identify a policy for the data processing system that specifies types of alerts and associated modalities of communication of the types of alerts. The management controller may initiate presentation of the alert to a user of the data processing system in accordance with the policy.

### FIELD

Embodiments disclosed herein relate generally to managing operation of data processing systems. More particularly, embodiments disclosed herein relate to systems and methods to manage alert communications via the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIG. 2 shows an interaction diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services, such as communication services. For example, the data processing system may be operated by a user and may provide communication services for the user through email, instant messaging, and/or video calls.

However, the user may need to rely on other (e.g., secondary) devices in order to obtain important time-sensitive communications, such as emergency alerts, since hardware resources of the data processing system may be unable to natively process the emergency alerts. The emergency alerts may include alerts broadcasted from cell towers using Wireless Emergency Alerts (WEAs) to WEA-enabled mobile devices, alerts broadcasted to radio and/or television devices using the Emergency Alert System (EAS), alerts broadcasted to radio devices by the National Oceanic and Atmospheric Administration (NOAA) Weather Radio system, and/or other types of alerts issued by other alert systems.

These emergency alerts may include life-saving information and/or may require immediate action (e.g., by the user); however, if the user does not have access to a secondary device configured to receive emergency alerts (e.g., if the secondary device is not nearby, or not powered on), then the user may not receive the emergency alerts timely, and any action required by the user may be delayed or not performed. Thus, to improve timely communication of emergency alerts to the user, the emergency alerts may be made available to the user via the data processing system using out-of-band methods.

To do so, the data processing system may include out-of-band components that operate independently from in-band components of the data processing system (e.g., the hardware resources). The out-of-band components may include functionality for communicating with remote systems using (e.g., cellular-based) out-of-band communication channels. The out-of-band components may obtain alerts from a remote service system via the out-of-band communication channels, and may process the alerts before presenting alert information to the user in accordance with policies for the data processing system. The alert information may be presented to the user in real-time via various modalities of communication specified by the policies.

By doing so, time-sensitive information such as emergency alerts may be presented to the user despite operation of the hardware resources (e.g., the hardware resources may be unpowered and/or compromised), and without relying on accessibility of a secondary device. As a result, the computer-implemented services provided to the user by the data processing system may be improved.

In an embodiment, a method for managing operation of a data processing system is provided. The method may include: obtaining, by a management controller of the data processing system and via an out-of-band communication channel, an alert, the alert being broadcasted by a service system using a wireless wide area network; and, making, by the management controller, a determination regarding whether the alert is valid.

In a first instance of the determination where the alert is valid, the method may include: identifying, by the management controller, a policy for the data processing system, the policy specifying types of alerts and associated modalities of communication of the types of alerts; and, initiating, by the management controller, presentation of the alert to a user of the data processing system in accordance with the policy.

The data processing system may include a network module adapted to separately advertise network endpoints for the management controller and hardware resources of the data processing system, the network endpoints being usable by the service system to address communications to the hardware resources and the management controller. Obtaining the alert from the service system may include obtaining the alert from the network module. The hardware resources may be unable to natively process the alert.

The management controller and the network module may be on separate power domains from the hardware resources so that the management controller and the network module are operable while the hardware resources are inoperable. The alert may be provided to the management controller while a portion of the hardware resources are inoperable due to being unpowered. The alert may be redirected by the management controller to other devices via the out-of-band communication channel while a portion of the hardware resources are inoperable due to being unpowered.

The associated modalities of communication may include at least one modality selected from a group consisting of: auditory communication; visual communication; and, tactile communication. The policy may define specific modalities of the associated modalities of communication for presenting the alert to the user when the hardware resources are inoperable due to being unpowered.

The out-of-band communication channel may run through the network module, and an in-band communication channel that services the hardware resources may also run through the network module.

Initiating presentation of the alert may include providing the alert to a software agent hosted by hardware resources of the data processing system via a sideband communication channel connecting the management controller and the hardware resources. The management controller may monitor operation of the hardware resources during presentation of the alert to the user.

Making the determination may include querying the service system to verify that the service system broadcasted the alert. Making the determination may include querying a third-party system to verify informational content of the alert, the third-party system being trusted to perform verifications for alerts broadcasted by the service system.

The policy may be defined by an administrator of the data processing system and/or the policy may be provided to the management controller via the out-of-band communication channel. The policy may be configurable by the user of the data processing system.

A non-transitory media may include instructions that when executed by a processor cause the computer-implemented method to be performed.

The data processing system may include the non-transitory media and a processor, and may perform the computer-implemented method when the computer instructions are executed by the processor.

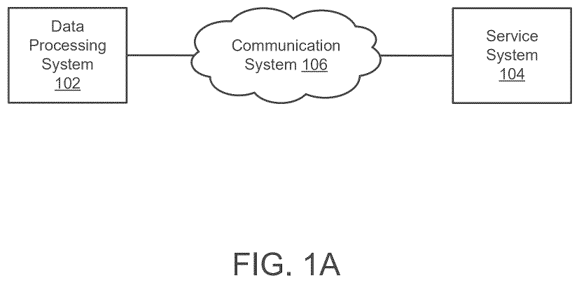

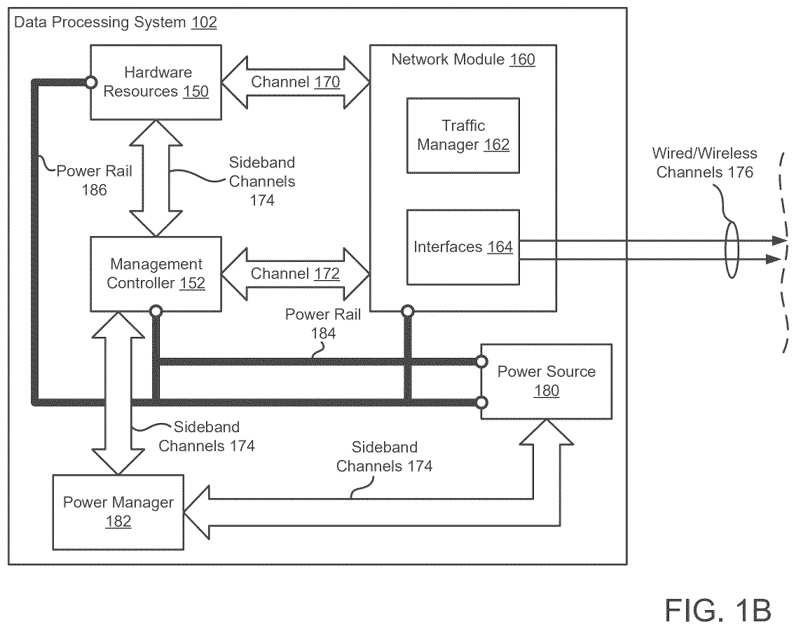

Turning to FIG. 1A, a block diagram illustrating a distributed system in accordance with an embodiment is shown. The system shown in FIG. 1A may provide computer-implemented services. The computer-implemented services may include any type and quantity of computer-implemented services. For example, the computer-implemented services may include communication services, data storage services, database services, data generation services, and/or any other type of service that may be implemented with a computing device. The computer-implemented services may be provided via cooperative interaction between components of the system of FIG. 1A. For example, a data processing system (e.g., data processing system 102) may obtain information from remote systems in the form of emails, instant messages, etc., and may present that information to a user of the data processing system (e.g., via a graphical user interface GUI and/or other software hosted by hardware resources of the data processing system).

A service system (e.g., service system 104) may issue communications over a network such as a cellular service network. The service system may broadcast alerts (e.g., emergency alerts) that include time-sensitive information regarding regional emergencies and/or actions for avoiding undesirable outcomes associated with the emergencies. The alerts may include information regarding dangerous and/or critical situations that may affect people within a specified geographical region. For example, the service system may use Cell Broadcast technology to broadcast text messages to mobile users that are located in specific geographical areas (e.g., to WEA-capable mobile devices in a geographical area may receive the text messages if their wireless carrier participates in the WEA program).

However, the data processing system may be unable to natively receive and/or process the alerts. Therefore, the user of the data processing system may be required to rely on secondary devices such as a tablet, pager, mobile phone, radio, and/or television to become aware of the alert. However, while operating data processing system, the user may not have access to a secondary device (e.g., the secondary device may not be proximate to the user, or may be unpowered), resulting in untimely delivery of the alert and/or a delayed or absent response to the emergency.

In general, embodiments disclosed herein may provide methods, systems, and/or devices for managing timely delivery of emergency alerts to a user of a data processing system such as a personal computer (PC). To do so, the data processing system may include out-of-band components that include functionality for receiving and processing information from systems that broadcast the emergency alerts over a wireless wide area network (WWAN).

By doing so, reliance on potentially inaccessible and/or non-operational secondary devices for obtaining information regarding emergencies may be reduced, and the user of the data processing system may be more likely to respond to an emergency in a manner that reduces negative impacts thereof.

To provide the above-mentioned functionality, the distributed system of FIG. 1A may include data processing system 102, service system 104, and communication system 106. The distributed system, any components thereof, and/or any other types of devices or components not shown in FIG. 1A may perform all, or a portion of the computer-implemented services independently and/or cooperatively. Each of these components is discussed below.

Data processing system 102 may include any number of data processing systems. Data processing system 102 may be operated directly or indirectly (e.g., through other devices) by any number of users. For example, a user may operate data processing system 102 to obtain computer-implemented services, which may include emergency alert communication services. To obtain the emergency alerts, data processing system 102 and/or components thereof may be registered to receive the emergency alerts (e.g., registered with a wireless provider/carrier).

To facilitate the emergency alert communication services, data processing system 102 may include out-of-band components, such as a management controller, that operate independently from hardware resources of data processing system 102. The management controller may be separately addressable to in-band components (e.g., hardware resources) of data processing system 102, and may therefore receive emergency alerts externally to the in-band components (e.g., even when the in-band components are unpowered). Refer to the discussion of FIG. 1B for more information regarding out-of-band components of data processing system 102.

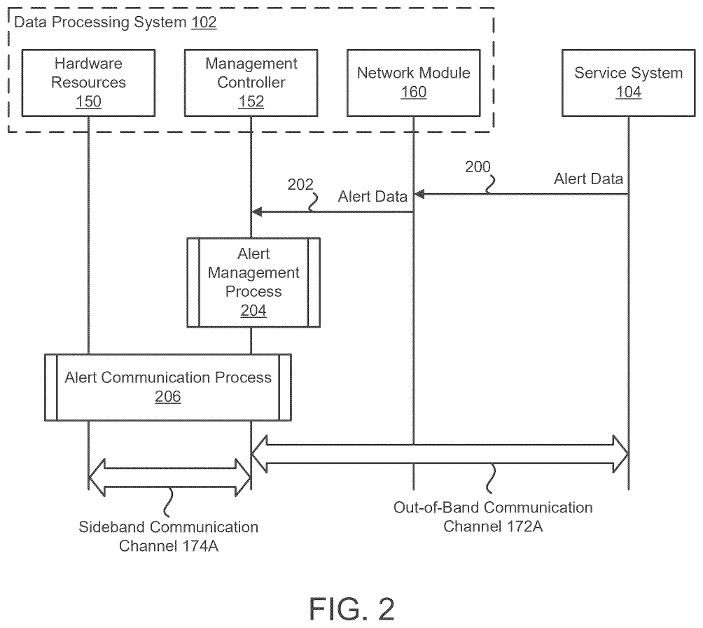

To provide the above-mentioned functionality, the management controller may, for example, (i) obtain, via WWAN out-of-band communication channels of data processing system 102, alerts (e.g., emergency alerts) from service system 104, (ii) validate the alerts via out-of-band communication with service system 104 and/or other systems, (iii) manage policies (e.g., alerting policies) for data processing system 102, (iv) initiate communication of the alerts to a user of data processing system 102 in accordance with policies (e.g., via communication with the hardware resources over sideband channels of data processing system 102), and/or (v) perform other actions relating to managing operation of data processing system 102. Refer to the discussion of FIG. 2 for more information regarding management of emergency alerts by data processing system 102.

Service system 104 may include any number and/or type of systems usable for providing (e.g., transmitting, broadcasting) information to devices (e.g., within a geographical region). For example, service system 104 may include any public safety system and/or integration of public safety systems (e.g., Integrated Public Alert and Warning System (IPAWS)). Service system 104 may broadcast weather alerts, government official alerts, public safety alerts, and/or other types of alerts (e.g., missing persons alerts) over a communication network. For example, service system 104 may broadcast emergency alerts over a WWAN to devices registered to receive the emergency alerts, such as out-of-band components of data processing system 102.

By doing so, data processing system 102 may be used to obtain and process emergency alerts broadcasted by service system 104 in a manner that increases a likelihood of real-time reception of the emergency alerts by the user and in accordance with policies of data processing system 102. As a result, the user may not need to rely on potentially unavailable secondary devices for real-time reception of the emergency alerts.

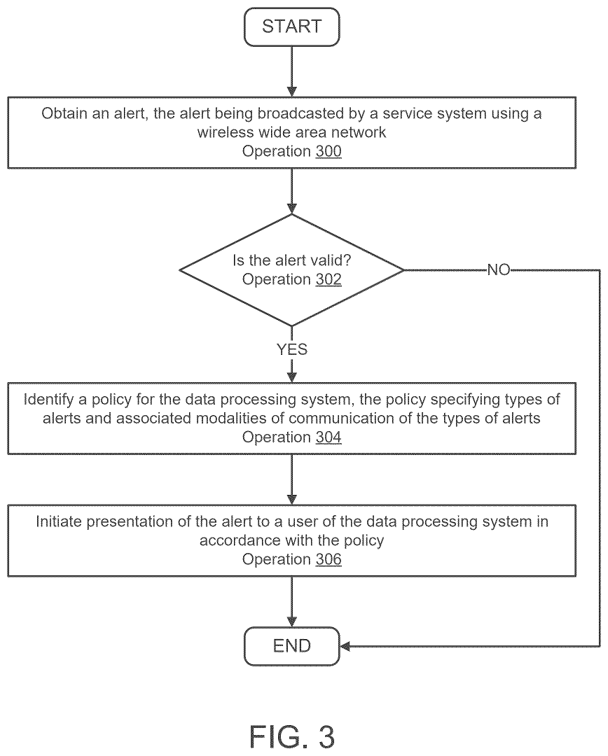

When providing their functionality, any of data processing system 102, service system 104, and/or components thereof may perform all, or a portion of the actions and methods illustrated in FIGS. 2-3.

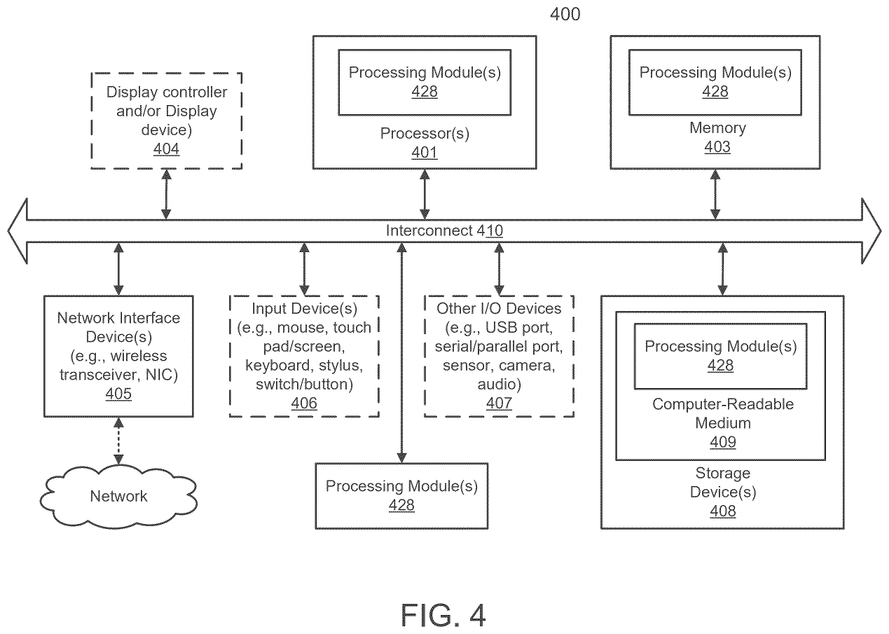

Any of data processing system 102 and service system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 106. Communication system 106 may facilitate communications between the components of FIG. 1A. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102 shown in FIG. 1B may be similar to any of the computing devices shown in FIG. 1A.

To provide computer-implemented services, data processing system 102 may include any quantity of hardware resources 150. Hardware resources 150 may be in-band (hardware) components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks. However, hardware resources 150 may not be unable to natively process (e.g., obtain and/or otherwise manage) emergency alert communications broadcasted by public safety systems (e.g., service system 104).

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, and to provide functionality for managing emergency alert communications, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150 of a host data processing system 102). Management controller 152 may provide various management functionalities for data processing system 102. Management controller 152 may, for example, monitor various ongoing processes performed by the in-band components, may manage power distribution, thermal management, and/or may perform other functions for managing data processing system 102. For example, management controller 152 may perform processes for managing emergency alerts for data processing system 102. To do so, management controller 152 may obtain, verify, and/or screen alert data (e.g., emergency alerts) to ensure timely presentation of emergency alert messages to intended recipients of the emergency alert message (e.g., a user of data processing system 102).

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels such as 174A shown in FIG. 2). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

For example, when managing emergency alert services for data processing system 102, management controller 152 may provide alert data to a software agent hosted by hardware resources 150 via the sideband channels during an alert communication process. To ensure the agent presents the alert data to a user of data processing system 102 in accordance with policies, management controller 152 may use the sideband channels to monitor (e.g., snoop) ongoing processes performed by hardware resources 150.

Management controller 152 may be operably connected to communication components of data processing system 102 via separate channels (e.g., 172, 172A shown in FIG. 2) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

To facilitate communication with other devices, data processing system 102 may include network module 160. Network module 160 may provide communication services for in-band components and out-of-band components (e.g., management controller 152) of data processing system 102. To do so, network module 160 may include traffic manager 162, and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

For example, when communicating with a remote system (e.g., service system 104), messages from the remote system may be addressed to a network endpoint advertised by network module 160 for out-of-band communications. The message may include emergency alert information. Once the message is received by traffic manager 162, traffic manager 162 may forward the message to management controller 152 via an out-of-band communication channel (e.g., channel 172), differentiating the message from in-band communications to data processing system 102. By doing so, data processing system 102 may be more likely to obtain authentic (e.g., unmodified by malicious parties) emergency alerts even when hardware resources 150 may be compromised and/or inoperable.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These component may support any number of wired/wireless channels 176.

For example, a network card of data processing system 102 may be dually attached to a cellular network and a Wi-Fi network. The network card and/or other cards of data processing system (e.g., a WWAN card) may be registered with a wireless provider/carrier to receive alerts via a WEA system and/or other types of alerting systems that deliver messages to multiple devices at once (e.g., in a particular geographic area over a certain period of time). For example, data processing system 102 may be configured to obtain messages from a Cell Broadcast service (i) at its time of manufacturing and/or (ii) after manufacturing by a user of data processing system 102 (e.g., by contacting an appropriate network provider for activation of the Cell Broadcast service).

Thus, from the perspective of an external device, the in-band components and out-of-band components of data processing system 102 may appear to be two independent network entities that may be independently addressable and/or otherwise unrelated to one another.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 is unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

Therefore, if hardware resources 150 are inoperable due to being unpowered, then out-of-band components may remain powered in order to manage emergency alert communications. For example, while hardware resources 150 are unpowered, power distribution may be managed so that management controller 152 may still (i) obtain emergency alerts, (ii) communicate with other devices (e.g., remote systems such as service system 104 and/or other systems) in order to obtain information usable to validate (e.g., verify authenticity of) emergency alerts the information, (iii) identify and query policies to screen and guide presentation of the emergency alerts to intended recipients of the emergency alerts, and/or (iv) perform other actions for facilitating timely communication of the emergency alerts to the user.

To implement the separate power domains, data processing system 102 may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, supplied via the power rails (e.g., by providing instructions via sideband channels 174). Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

To further clarify embodiments disclosed herein, an interaction diagram in accordance with an embodiment is shown in FIG. 2. The interaction diagram may illustrate how data may be obtained and used within the system of FIGS. 1A-1B.

In the interaction diagrams, processes performed by and interactions between components of a (distributed) system in accordance with an embodiment are shown. In the diagrams, components of the system are illustrated using a first set of shapes (e.g., 150, 152, etc.), located towards the top of each figure. Lines descend from these shapes. Processes performed by the components of the system are illustrated using a second set of shapes (e.g., 204, 206) superimposed over these lines. Interactions (e.g., communication, data transmissions, etc.) between the components of the system are illustrated using a third set of shapes (e.g., 200, 202) that extend between the lines. The third set of shapes may include lines terminating in an arrow to indicate directional interactions between components, such as one-way interactions (e.g., data transmission from a first component to a second component) occur.

Thick arrows (e.g., sideband communication channel 174A, out-of-band communication channel 172A) may indicate communication channels that facilitate multi-way interactions (e.g., data transmission between two components).

Generally, the processes and interactions are temporally ordered in an example order, with time increasing from the top to the bottom of each page. For example, the interaction labeled as 200 may occur prior to the interaction labeled as 202. However, it will be appreciated that the processes and interactions may be performed in different orders, any may be omitted, and other processes or interactions may be performed without departing from embodiments disclosed herein.

Turning to FIG. 2, an interaction diagram in accordance with an embodiment is shown. The interaction diagram may illustrate processes and interactions that may occur during management of alerts issued to a data processing system. The data processing system (e.g., data processing system 102) and may include hardware resources 150, management controller 152, network module 160, and/or other components (not shown).

To communicate alerts (e.g., emergency alerts) to an intended audience, service system 104 may make alert data (e.g., information regarding emergency alerts) available to various devices. For example, service system 104 may broadcast, using a broadcast technology (e.g., Cell Broadcast technology), alert data to registered devices located within a region, over a period of time. Network module 160 may include functionality (e.g., WWAN functionality) for establishing secure connections with a cellular network service over which service system 104 broadcasts the alert data. For example, during the broadcast, the alert data may be obtained by network module 160.

At interaction 200, the alert data may be obtained from service system 104 by network module 160. For example, the alert data may be generated and provided over a wired or wireless communication channel (e.g., of wired/wireless channels 176) via (i) transmission via a message (e.g., to a network endpoint addressed to management controller 152), (ii) storing in a storage with subsequent retrieval by network module 160, (iii) a publish-subscribe system where network module 160 subscribes to updates from service system 104 thereby causing a copy of the alert data to be propagated to network module 160, and/or (iv) other processes. Upon obtaining the alert data, network module 160 may forward the alert data to management controller 152 over an out-of-band communication channel (e.g., 172A).

At interaction 202, the alert data may be obtained from network module 160 by management controller 152. For example, the alert data may be provided over out-of-band communication channel 172A via (i) transmission via a message, (ii) storing in a storage with subsequent retrieval by management controller 152, (iii) a publish-subscribe system where management controller 152 subscribes to updates from network module 160 thereby causing a copy of the alert data to be propagated to management controller 152, and/or (iv) other processes. Refer to the discussion of FIG. 1B for more information regarding network traffic management for data processing system 102. Upon obtaining the alert data, management controller 152 may perform and/or initiate alert management services.

To provide the alert management services, management controller 152 may perform alert management process 204. During alert management process 204, management controller 152 may determine whether the alert data is valid. For example, management controller 152 may verify that the alert data is authentic (e.g., the alert data is obtained from a trusted source and/or was not modified during transit). Based on the validation, fraudulent alert data may be detected and filtered (e.g., not presented to a user of data processing system 102), and authentic alert data may be processed further.

For example, management controller 152 may (i) communicate with service system 104 to verify that service system 104 broadcasted the alert and/or (ii) communicate with a third-party system (e.g., trusted to perform verifications for alerts broadcasted by service system 104) in order to verify informational content of the alert data. During validation of the alert data, hashes and/or other types of cryptographic data may be used to verify informational content of the alert data. If the alert data is determined to be valid (e.g., management controller 152 is able to verify authenticity of the alert data), then the alert may be processed in accordance with policies (e.g., alerting policies) for data processing system 102.

During alert management process 204, management controller 152 may identify a type of alert for the alert data. For example, types of alerts may include types of missing persons alerts (e.g., silver alerts, amber alerts), types of weather alerts (e.g., tornado warnings, flood warnings, high wind warnings), types of government official alerts (e.g., Presidential addresses), and/or other types or subtypes of emergency alerts. A policy for data processing system 102 may be identified, for example, based on the type of alert for the alert data (e.g., if multiple policies are defined for different types of alerts).

The policy (e.g., policies) may be stored in hardware resources 150 and/or in local memory of management controller 152. For example, management controller 152 may identify a policy stored in hardware resources 150 through communication with hardware resources 150 over sideband communication channel 174A (not shown). Or, for example, management controller 152 may manage and/or host policies for data processing system 102, and the policies may be pushed to an operating system hosted by hardware resources 150 (e.g., to ensure use of authentic and/or up to date policies).

Policies for data processing system 102 (e.g., the policy) may be defined by an administrator of data processing system 102 and/or may be provided to (e.g., pushed to) management controller 152 from a remote system (e.g., a policy management system operated by the administrator) via out-of-band communication channel 172A (not shown). Management controller 152 may subscribe to policy updates from the administrator; therefore, policies may be pushed to management controller 152 at various points in time. For example, the policy may have been provided to data processing system 102 prior to interaction 200.

The policy identified during alert management process 204 may relate to management of emergency alerts by management controller 152 and may specify associated modalities of communication for different types of alerts. The policy may be configurable by the user of data processing system 102. For example, the user may activate different types of alerts for which the user desires to be notified and/or modalities of communication for the different types of alerts.

The modalities of communication may include at least one modality selected from a group of modalities, such as auditory communication (e.g., a sound may be played and/or other sounds may be attenuated), visual communication (e.g., a pop-up message may appear on a GUI, a light in a field of view of the user may flicker), tactile communication (e.g., a vibration, a tap, or other touch-based sensation may be sensed by the user), and/or combinations thereof. For example, the user may specify different types of sounds, pop-ups, and/or vibration patterns for each type of alert the user activates.

The policy may be configured to override other configuration settings. For example, a sound may be played to indicate receipt of an alert, even when speakers of data processing system 102 are muted. The policy may be configurable based on (i) types of alerts, (ii) types of modalities of communication, (iii) times of day, and/or (iv) other types of information as specified by the user (e.g., calendar information for the user).

The alert management services may be performed even while hardware resources 150 of data processing system 102 are inoperable (e.g., due to being unpowered). For example, management controller 152 may distribute power to network module 160 and/or other components of data processing system required for obtaining and processing the alert data. In other words, management controller 152 may track emergency alerts issued to data processing system 102 while hardware resources 150 are powered off.

In some cases (e.g., when hardware resources 150 are unpowered, inoperable, and/or in circumstances such as when the user is not currently operating data processing system 102), the policy may specify that the alert data is to be redirected by management controller 152 to other devices via out-of-band communication channel 172A (not shown). The other devices may include PCs and/or mobile devices (e.g., tablets, pagers, mobile phones, wearables) associated with data processing system 102 and/or a user thereof. Enforcement of the policy may also trigger management controller 152 to generate data.

For example, management controller 152 may compose an email regarding the alert (e.g., addressed to the user or other individuals specified by the policy) and/or generate other types of data on behalf of the user (e.g., generate an instant message from a specified account to other specified accounts, generate social media posts and/or direct messages via social media).

When hardware resources 150 are operational (e.g., powered and/or otherwise available), and depending on the type of alert and actions defined by the policy for the type of alert, management controller 152 may initiate alert communication process 206. During alert communication process 206, at least a portion of the alert data may be presented to the user. Portions of alert communication process 206 may be performed cooperatively and/or independently by management controller 152 and hardware resources 150.

During alert communication process 206, management controller 152 may provide the alert data and/or other information (e.g., computer instructions, the policy) to a software agent hosted by hardware resources 150 (e.g., an operating system of data processing system 102) via sideband communication channel 174A. For example, management controller 152 may push policies to hardware resources 150 so that policies enforced by the software agent are appropriate (e.g., not tampered with).

Alert communication process 206 may be managed by the software agent. Therefore, management controller 152 may use sideband communication channel 174A to monitor operation of hardware resources 150. Management controller 152 may verify that activity of hardware resources 150 is appropriate for enforcing the policy. For example, during an attack on data processing system 102, a malicious party may gain control of hardware resources 150 and may be able to modify policies stored in hardware resources 150 and/or shut off policy enforcement. To reduce impacts of the attack, management controller 152 may (i) detect unexpected activity and/or policy use, and/or (ii) perform actions for mitigating or preventing the attack (e.g., reporting the unexpected activity to other systems, initiating a shut-down process for data processing system 102).

During alert communication process 206, the software agent may generate and/or execute computer instructions so that at least a portion of the alert data (e.g., the information regarding the emergency alert) is presented to the user for consumption in accordance with the policy. For example, the user may view a pop-up message (e.g., text displayed on a GUI), sense a vibration, and/or hear a sound that indicate information included in the alert data.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIG. 2, time-sensitive information such as emergency alerts may be conveyed to a user of a data processing system (e.g., PC) in real-time, by using out-of-band methods. By doing so, the user may be more likely to receive authentic emergency alert communications in situations where secondary devices may be unreliable for doing so, while leveraging existing infrastructure of cellular networks used to broadcast the emergency alerts.

Turning to FIG. 3, a flow diagram illustrating a method in accordance with an embodiment is shown. The flow diagram may illustrate various operations performed while managing operation of the data processing system. The data processing system may be used to communicate emergency alerts to a user of the data processing system.

At operation 300, an alert broadcasted by a service system using a wireless wide area network may be obtained. The alert (e.g., an emergency alert) may be obtained by methods described with respect to interactions 200-202 of FIG. 2 and/or by other methods. For example, a management controller of the data processing system may obtain the alert from a network module of the data processing system, (e.g., since hardware resources of the data processing system may be unable to natively process the alert). The management controller may obtain the alert from the network module by (i) receiving the alert via an out-of-band communication channel of the data processing system that connects the network module with the management controller, (ii) reading the alert from storage, and/or (iii) generating the alert.

The alert may be provided to the management controller while a portion of the hardware resources are inoperable due to being unpowered. For example, the management controller may distribute power to the network module and/or other components so that the alert may be obtained by the network module before being forwarded to the management controller.

At operation 302, a determination may be made regarding whether the alert is valid. The determination may be made by (i) querying the service system to verify that the service system broadcasted the alert, and/or (ii) querying a third-party system to verify informational content of the alert. For example, the management controller may query the service system by transmitting a message to the service system requesting verification. The third-party system may be trusted to perform verifications for alerts broadcasted by the service system and/or may serve as a secondary (e.g., independent) source for the alerts. The management controller may query the third-party system by transmitting a message to the third-party system requesting verification (e.g., authentication) of the alert. The verification may include authenticating the alert based on cryptographic information for the alert (e.g., using a hash and/or a public key) and/or other methods.

Based on a response from the service system and/or the third-party system, the management controller may make the determination regarding whether the alert is valid. For example, if the management controller is able to verify (e.g., authenticate) the alert and/or informational content thereof using response(s) from the services system and/or the third-party system, then the alert may be considered valid. Otherwise, if the management controller is unable to verify the alert and/or informational content thereof using at least one of the responses obtained during verification of the alert, then the alert may not be considered valid.

In a first instance of the determination where the alert is valid, the method may proceed to operation 304 following operation 302. In a second instance of the determination where the alert is not valid, the method may end following operation 302.

At operation 304, in a first instance where the alert is valid, a policy for the data processing system may be identified. The policy may be identified by (i) reading a data structure (e.g., the alert, alert data) to classify the data structure as an emergency alert (or other type of data structure), and/or (ii) selecting a policy that defines management of emergency alerts. For example, the management controller may select the policy from local storage and/or from a storage medium of the hardware resources (e.g., using a sideband channel that connects the hardware resources with the management controller).

Identifying the policy may also include (i) identifying a type of the alert, and/or (ii) selecting a policy keyed to the type of the alert. For example, the policy may specify types of alerts and associated modalities of communication of the types of alerts and/or policies keyed to different types of alerts may be defined for the data processing system. For more information regarding policies and/or modalities of communication of alerts, refer to the discussion of FIG. 2 (e.g., alert communication process 206).

At operation 306, presentation of the alert to a user of the data processing system may be initiated in accordance with the policy. Presentation of the alert may be initiated by (i) reading the policy to identify a modality of communication for the alert, (ii) obtaining instructions for communicating the alert using the modality of communication, and/or (iii) providing the alert, the policy, and/or the instructions to the hardware resources (e.g., a software agent hosted by the hardware resources) via a sideband communication channel connecting the management controller and the hardware resources.

For example, the management controller may initiate presentation of the alert to the user using methods described with respect to alert communication process 206 of FIG. 2 and/or by other methods. To initiate presentation of the alert to the user while a portion of the hardware resources are inoperable due to being unpowered, the management controller may redirect the alert to other devices via the out-of-band communication channel. The management controller may do so by managing power distribution for the data processing system and providing power to the network module to facilitate the redirection of the alert.

The method may end following operation 306.

Thus, as illustrated above, embodiments disclosed herein may provide systems and methods usable to manage operation of a data processing system in accordance with policies that define emergency alert communication. The operation of the data processing system may be managed by out-of-band components of the data processing system, tasked with obtaining the emergency alerts via out-of-band communication channels, and processing the emergency alerts in accordance with policies. By doing so, the emergency alerts may be presented to a user of the data processing system in a desired manner, using modalities of communication specified by the policies.

Thus, embodiments disclosed herein may provide an improved computing device that may automatically manage provision of a computer-implemented service for emergency alert communication in a manner that reduces a likelihood of interruptions to the computer-implemented service. Accordingly, the disclosed process provides for both an embodiment in computing technology and an improved method for managing emergency alerts via the data processing system.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining, by a management controller of the data processing system and via an out-of-band communication channel, an alert, the alert being broadcasted by a service system using a wireless wide area network;
making, by the management controller, a determination regarding whether the alert is valid; and
in a first instance of the determination where the alert is valid;
identifying, by the management controller, a policy for the data processing system, the policy specifying types of alerts and associated modalities of communication of the types of alerts; and
initiating, by the management controller, presentation of the alert to a user of the data processing system in accordance with the policy.

2. The method of claim 1, wherein the data processing system comprises a network module adapted to separately advertise network endpoints for the management controller and hardware resources of the data processing system, the network endpoints being usable by the service system to address communications to the hardware resources and the management controller.

3. The method of claim 2, wherein obtaining the alert from the service system comprises obtaining the alert from the network module.

4. The method of claim 3, wherein the management controller and the network module are on separate power domains from the hardware resources so that the management controller and the network module are operable while the hardware resources are inoperable.

5. The method of claim 4, wherein the alert is provided to the management controller while a portion of the hardware resources are inoperable due to being unpowered.

6. The method of claim 5, where in the alert is redirected by the management controller to other devices via the out-of-band communication channel while a portion of the hardware resources are inoperable due to being unpowered.

7. The method of claim 6, wherein the policy defines specific modalities of the associated modalities of communication for presenting the alert to the user when the hardware resources are inoperable due to being unpowered.

8. The method of claim 2, wherein the out-of-band communication channel runs through the network module, and an in-band communication channel that services the hardware resources also runs through the network module.

9. The method of claim 1, wherein initiating presentation of the alert comprises providing the alert to a software agent hosted by hardware resources of the data processing system via a sideband communication channel connecting the management controller and the hardware resources.

10. The method of claim 9, wherein the management controller monitors operation of the hardware resources during presentation of the alert to the user.

11. The method of claim 10, wherein the hardware resources are unable to natively process the alert.

12. The method of claim 1, wherein making the determination comprises:
querying the service system to verify that the service system broadcasted the alert.

13. The method of claim 1, wherein making the determination comprises:
querying a third-party system to verify informational content of the alert, the third-party system being trusted to perform verifications for alerts broadcasted by the service system.

14. The method of claim 1, wherein the policy is defined by an administrator of the data processing system and/or the policy is provided to the management controller via the out-of-band communication channel.

15. The method of claim 1, wherein the policy is configurable by the user of the data processing system.

16. The method of claim 1, wherein the associated modalities of communication comprise at least one modality selected from a group consisting of:
auditory communication;
visual communication; and
tactile communication.

17. A non-transitory machine-readable medium having instructions stored therein, which when executed by a processor, cause the processor to perform operations for managing operation of a data processing system, the operations comprising:
obtaining, by a management controller of the data processing system and via an out-of-band communication channel, an alert, the alert being broadcasted by a service system using a wireless wide area network;
making, by the management controller, a determination regarding whether the alert is valid; and
in a first instance of the determination where the alert is valid;
identifying, by the management controller, a policy for the data processing system, the policy specifying types of alerts and associated modalities of communication of the types of alerts; and
initiating, by the management controller, presentation of the alert to a user of the data processing system in accordance with the policy.

18. The non-transitory machine-readable medium of claim 17, wherein the data processing system comprises a network module adapted to separately advertise network endpoints for the management controller and hardware resources of the data processing system, the network endpoints being usable by the service system to address communications to the hardware resources and the management controller.

19. A data processing system, comprising:
a processor; and
a memory coupled to the processor to store instructions, which when executed by the processor, cause operations for managing the data processing system to be performed, the operations comprising:
obtaining, by a management controller of the data processing system and via an out-of-band communication channel, an alert, the alert being broadcasted by a service system using a wireless wide area network,
making, by the management controller, a determination regarding whether the alert is valid, and
in a first instance of the determination where the alert is valid,
identifying, by the management controller, a policy for the data processing system, the policy specifying types of alerts and associated modalities of communication of the types of alerts; and
initiating, by the management controller, presentation of the alert to a user of the data processing system in accordance with the policy.

20. The data processing system of claim 19, further comprising:
a network module adapted to separately advertise network endpoints for the management controller and hardware resources of the data processing system, the network endpoints being usable by the service system to address communications to the hardware resources and the management controller.
